(19) United States
(12) Patent Application Publication
(10) Pub. No.: US 2016/0223105 A1
(43) Pub. Date: Aug. 4, 2016

(54) FLEXIBLE SPRINKLER HOSE CONNECTING DEVICE

(71) Applicant: Kofulso Co., Ltd., Incheon-si (KR)

(72) Inventor: Seung-il OH, Seoul (KR)

(73) Assignee: Kofulso Co., Ltd.

(21) Appl. No.: 14/608,669

(22) Filed: Jan. 29, 2015

(51) Int. Cl. F16L 19/025; F16L 11/08

(52) U.S. Cl. CPC F16L 19/025; F16L 11/085

(57) ABSTRACT

The present invention relates to a flexible sprinkler hose connecting device that has a nipple rotatably fitted to one side of a flexible hose connected to a feeder pipe and a fixture fastened and unfastened to and from the other side of the flexible hose only by means of an exclusive tool, thus conveniently connecting the flexible hose to the feeder pipe and a sprinkler head, without fear of leakage.

### BACKGROUND OF THE INVENTION

1. Field of the Invention

The present invention relates to a flexible sprinkler hose connecting device, and more particularly, to a flexible sprinkler hose connecting device that has a nipple rotatably fitted to one side of a flexible hose connected to a. feeder pipe and a fixture fastened and unfastened to and from the other side of the flexible hose only by means of an exclusive tool, thus conveniently connecting the flexible hose to the feeder pipe and a sprinkler head, without fear of leakage.

2. Background of the Related Art

Generally, a flexible sprinkler hose is installed between a feeder pipe located at the inside of a ceiling and a sprinkler head so as to supply water when a fire occurs.

As shown in FIGS. 1 and 2, a conventional flexible sprinkler hose connecting device is configured wherein coupling members to which a nipple 140 coupled to a feeder pipe and a reducer 150 are coupled have the same connection structure as each other. That is, nuts 111 and 112 and fixtures 121 and 122 are fitted to a flexible hose 100, and locking portions 101 and 102 are formed on both sides of the flexible hose 100 in such a manner as to be increased in diameter through the compression. of the flexible hose 100. The locking portions 101 and 102 serve to prevent the nuts 111 and 112 and the fixtures 121 and 122 from being escaped from the flexible hose 100. The nuts 111 and 112 have packings 131 and 132 fitted thereto in such a manner as to be brought into contact with the flanges of the fixtures 121 and 122. The nipple 140 is coupled to one side nut 111 and the reducer 150 to the other side nut 112. After that, the feeder pipe side flexible hose 100 is connected to the nipple 140, and the reducer 150 is coupled to a sprinkler head.

According to the conventional flexible sprinkler hose connecting device, by the way, the water tightness on the coupled portions of the flexible hose 100 with the nipple 140 and the reducer 150 is maintained just by means of the packings 131 and 132, thus undesirably causing frequent leakage. So as to couple the reducer 150 to the flexible hose 100, further, while the nut 112 is being taken by one hand of a worker standing on a repair stand and looking up toward the ceiling, the reducer 150 is turned by the other hand of worker, thus undesirably causing safety accidents.

### SUMMARY OF THE INVENTION

Accordingly, the present invention has been made in view of the above-mentioned problems occurring in the prior art, and it is an object of the present invention to provide a flexible sprinkler hose connecting device that has a nipple rotatable fitted to one side of a flexible hose connected to a feeder pipe and a fixture fastened and unfastened to and from the other side of the flexible hose only by means of an exclusive tool, so that the reducer can be coupled to the fixture only by a worker's one hand in the state where only the nipple is rotated and coupled to the feeder pipe, thus allowing the worker to take a more stable posture.

it is another object of the present invention to provide a flexible sprinkler hose connecting device that maintains the water tightness on the coupled portion of flexible hose with a nipple by means of a packing contacted with the coupled portion and rotates a fixture only with an exclusive tool, so that the fixture is assembled to the flexible hose at an optimal state in the factory, thus maintaining the non-leakage state even upon the installation of the flexible hose and further removing the occurrence of leakage on the coupled portions of the flexible hose.

To accomplish the above-mentioned objects, according to the present invention, there is provided a flexible sprinkler hose connecting device including: a flexible hose having troughs and peaks continuously formed therealong and surrounded by a braided layer; first and second non-flexible portions formed on both ends of the flexible hose; first and second internal rings and first and second external rings located on the inner and outer peripheries of the braided layer to fix the end portions of the braided layer to the first and second non-flexible portions; a bushing having a first coupling hole to which the first external ring is fitted, a first through hole connected to the first coupling hole, a first compression groove formed on the first through hole, and a guide groove formed on the outer periphery thereof; a first internal packing insertedly fitted to the first compression groove; external packings disposed on the outer periphery of the bushing; a first expansion portion formed by convexedly expanding a portion of the first non-flexible portion toward the first compression groove in the state where the bushing is fitted to first non-flexible portion; a nipple having screw holes formed on the outer peripheral surface thereof to correspond to the guide groove of the bushing in such a manner as to be penetrated into a fitting hole formed in the interior thereof; headless bolts fitted to the guide groove through the screw holes; a fixture having a second coupling hole to which the second external ring is fitted, a second through hole connected to the second coupling hole, a second compression groove formed on the second through hole, and an exclusive tool fitting groove formed on the outer periphery thereof; a second internal packing fitted to the second compression groove; a second expansion portion formed by convexedly expanding a portion of the second non-flexible portion toward the second compression groove in the state where the fixture is fitted to the second non-flexible portion; and first and second bending portions formed on the end peripheral portions of the first and second non-flexible portions to fix the bushing and the fixture to the flexible hose.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view showing a conventional flexible sprinkler hose connecting device;

FIG. 2 is a sectional view showing the coupled state of the conventional flexible sprinkler hose connecting device;

FIG. 3 is an exploded perspective view showing a flexible sprinkler hose connecting device according to the present invention;

FIG. 4 is a sectional view showing the coupled state of the flexible sprinkler hose connecting device according to the present invention;

FIG. 5 is an expanded sectional view showing the state where the ends of a braided layer are fixed by means of the compression of external rings;

FIG. 6 is a sectional view showing the state before an expansion portion is formed;

FIG. 7 is a sectional view showing the state after the expansion portion is formed; and

FIG. 8 is an exemplary view showing the state where the flexible hose is mounted on a ceiling.

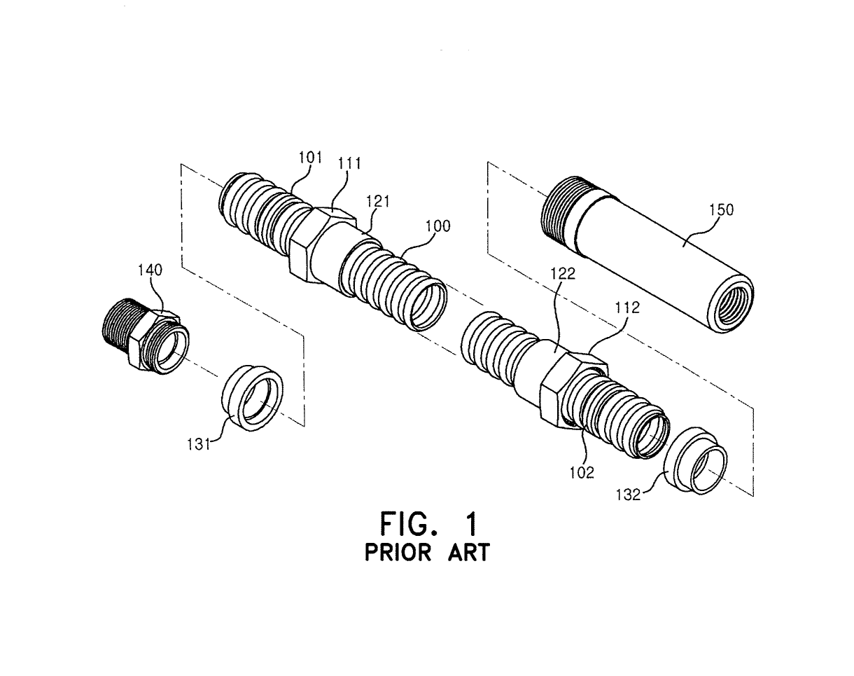

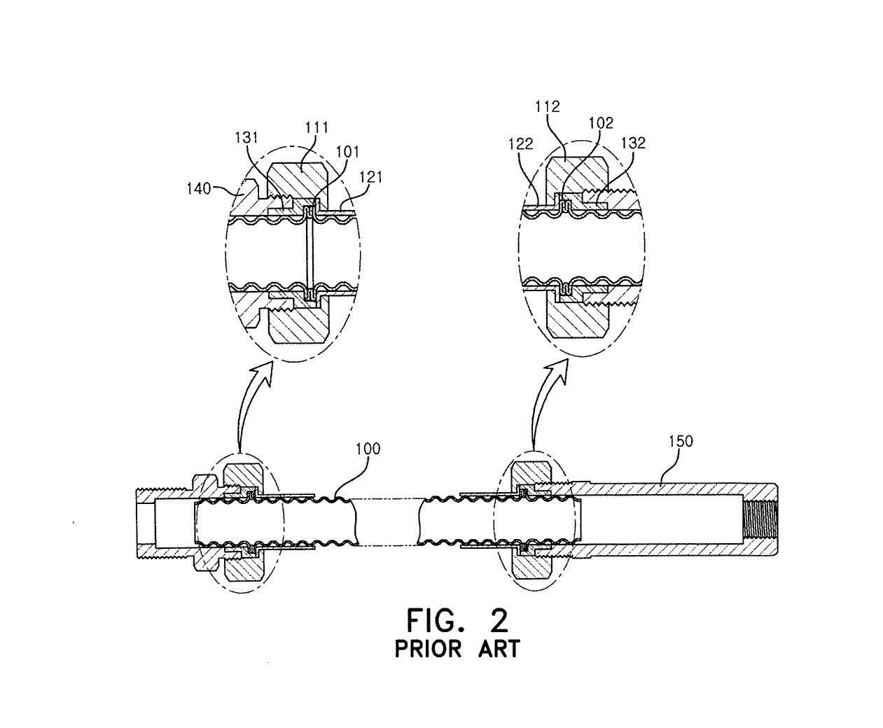

### DETAILED DESCRIPTION OF THE PREFERRED EMBODIMENTS

Hereinafter, an explanation on a flexible sprinkler hose connecting device according to the present invention will be in detail given with reference to the attached drawing.

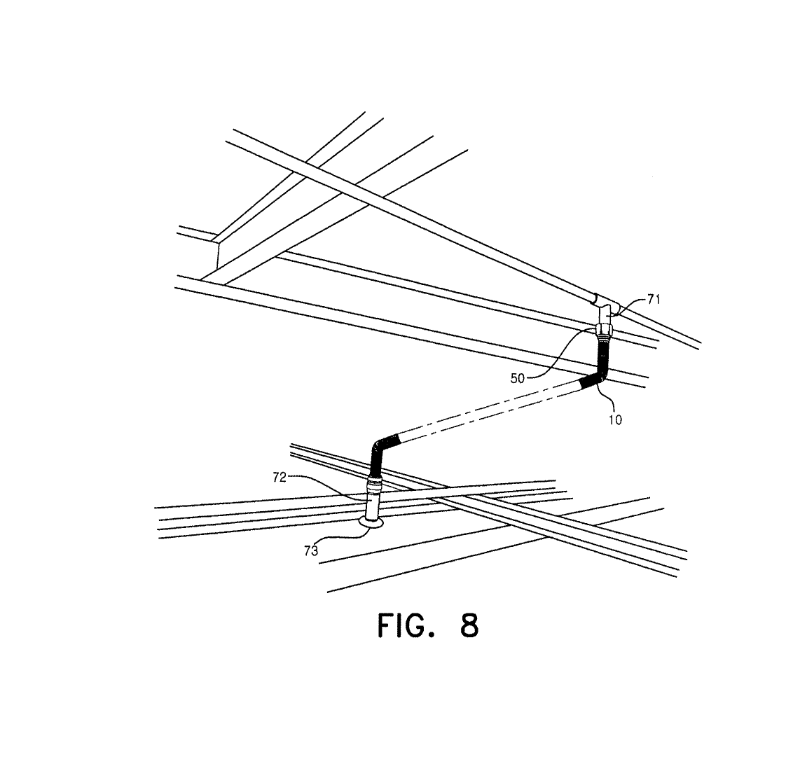

As shown in FIG. 8, the present invention relates to a flexible sprinkler hose connecting device which connects a flexible hose 10 between a feeder pipe 71 and a reducer 72 on which a sprinkler head 73 is mounted, and the flexible hose 10 is made of a metal material and has troughs and peaks continuously formed therealong.

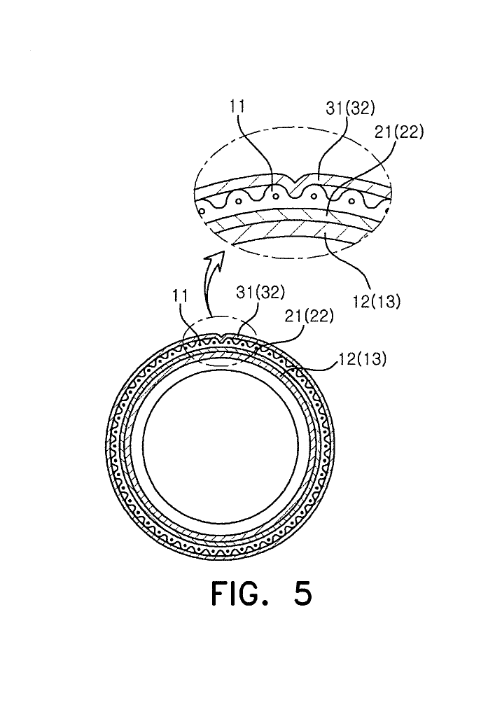

According to the present invention, the flexible hose 71 is surrounded by a braided layer 11 and has first and second non-flexible portions 12 and 13 formed on both ends thereof. Both sides of the braided layer 11 are removed to allow the portions of the first and second non-flexible portions 12 and 13 to be exposed, and both end portions of the braided layer 11 are fitted between first and second internal rings 21 and 22 and first and second external rings 31 and 32. As shown in FIG. 5, the first and second internal rings 21 and 22 and the first and second external rings 31 and 32 are compressed to fix the braided layer 11 to the first and second non-flexible portions 12 and 13. The first and second non-flexible portions 12 and 13 are portions wherein no troughs and peaks are formed like a pipe.

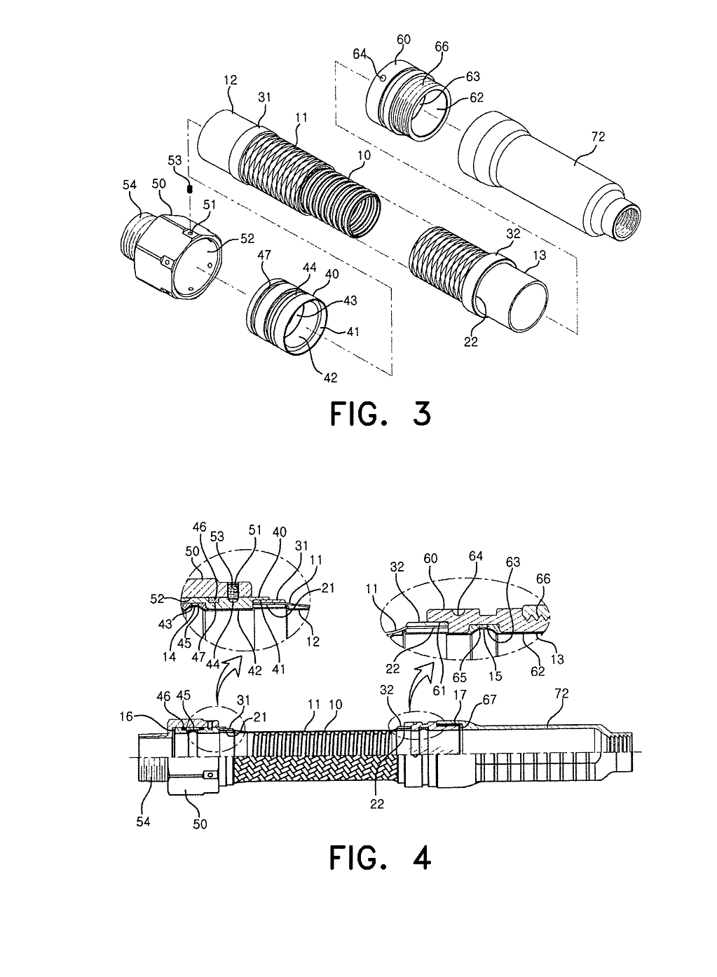

As shown in FIGS. 3 and 4, a bushing 40 and a nipple 50 connect the flexible hose 10 to the feeder pipe 71, and a fixture 60 connects the flexible hose 10 to the reducer 72.

The bushing 40 has a first coupling hole 41 to which the first external ring 31 is fitted, a first through hole 42 connected to the first coupling hole 41, first compression groove 43 formed on the first through hole 42, and a guide groove 44 formed on the outer periphery thereof.

A first internal packing 45 is insertedly fitted to the first compression. groove 43, and one or more external packings 46 are disposed on the outer periphery of the bushing 40. The first internal packing 45 and the external packings 46 are made of an elastic material like rubber to keep water tightness. The first internal packing 45 has a given thickness. Each external packing 46 has a shape of a ring having a circular section, and packing grooves 47 are formed on the outer periphery of the bushing 40 to fit portions of the external packings 46 thereto, so that even if the external packings 46 are pressedly disposed, they are not deviated from their given positions.

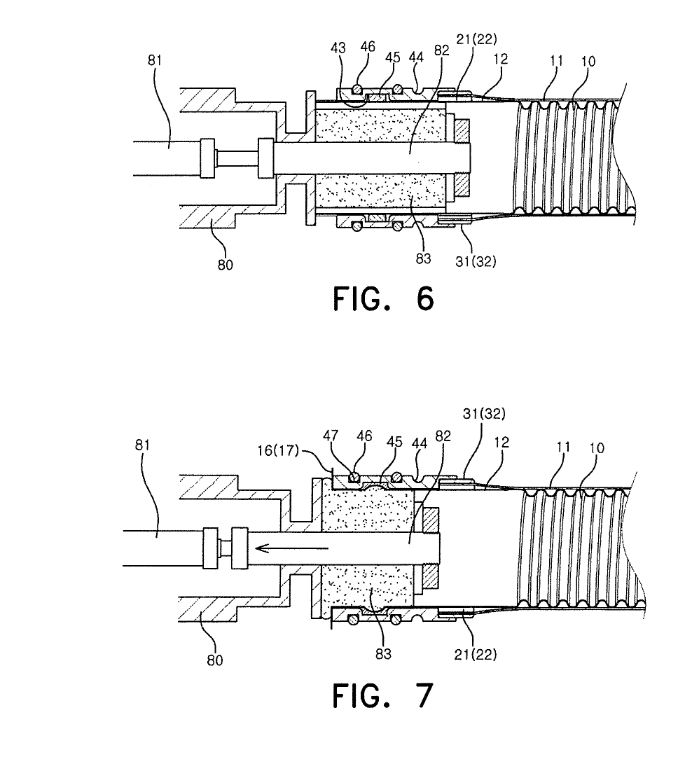

As shown in FIG. 6, the bushing 40 is fitted to the first non-flexible portion 12, and the first external ring 31 is fitted to the first coupling hole 41. As shown in FIG. 7, a first expansion portion 14 is formed by convexedly expanding a portion of the first non-flexible portion 12 toward the first compression groove 43. As shown in FIGS. 6 and 7, the first expansion portion 14 includes: a moving body 80 in which a cylinder 81 is disposed; a cylinder shaft 82 protruding from one side of the moving body 82; and urethane rubber 83 compressed by means of the cylinder 81, which are well-known in the art. If the moving body 80 moves in the state where the urethane rubber 83 is inserted into the first non-flexible portion 12, the end peripheral portion of the first non-flexible portion 12 is bent to form a first bending portion 16 coming into contact with the bushing 40, thus allowing the bushing 40 to be fixedly mounted to the first non-flexible portion 12. In this state, if the cylinder 81 is operated to compress the urethane rubber 83, the first non-flexible portion 12 changeable in shape around the first compression groove 43 is formed convexedly toward the first compression groove 43.

The nipple 50 has screw holes 51 formed on the outer peripheral surface thereof to correspond to the guide groove 44 of the bushing 40 and penetrated into a fitting hole 52 formed in the interior thereof. Headless bolts 53 are fitted to the guide groove 44 through the screw holes 51. The headless bolts 53 are guided along the guide groove 44 to allow the nipple 50 to be freely rotated with respect to the bushing 40 and at the same time to prevent the nipple 50 from being escaped from the bushing 40.

A screw portion 54 formed on one side portion of the nipple 50 is coupled to a connector of the feeder pipe 71.

The fixture 60 has a second coupling hole 61 to which the second external ring 32 is fitted, a second through hole 62 connected to the second coupling hole 61, a second compression groove 63 formed on the second through hole 62, and an exclusive tool fitting groove 64 formed on the outer periphery thereof. A second internal packing 65 is fitted to the second compression groove 63, and in the state where the fixture 60 is fitted to the second non-flexible portion 13 and the second external. ring 32 is coupled to the second coupling hole 61, a portion of the second non-flexible portion 13 is expanded convexedly toward the second compression groove 63, thus forming a second expansion portion 15. The second expansion portion 15 is formed in the same manner as the first expansion portion 14 through the known expansion means, and the second internal packing 65 performs the same functions as the first internal packing 45.

A second bending portion 17 coming into contact with the fixture 60 is formed on the end peripheral portion of the second non-flexible portion 13 upon the expansion of the second non-flexible portion 13, thus allowing the fixture 60 to be fixedly mounted to the second non-flexible portion 13.

The fixture further has a screw portion 66 formed on one side periphery thereof in such a manner as to be coupled to the reducer 72.

According to the present invention, the flexible hose 10 formed integrally with the connecting device is made by cutting both sides of the braided layer 11 in a factory, fitting and compressing the braided layer 11 between the first and second internal rings 21 and 22 and the first and second external rings 31 and 32 (See FIG. 5), forming the first and second expansion portions 14 and 15 and the first and second bending portions 16 and 17 by means of the known expansion means in the state wherein the bushing 40 and the fixture 60 are fitted to the first and second non-flexible portions 12 and 13 (See FIGS. 6 and 7), and fitting the nipple 50 to the bushing 40 and coupling them by means of the headless bolts 53. At this time, the fixture 60 is coupled by means of the second internal packing 65 and a gasket 67 to completely keep water tightness and fixed to the second bending portion 17, so that the fixture 60 can be rotated only with the exclusive tool fitted to the fitting groove 64. That is, there is no need for holding the fixture 60 upon fixing to the reducer 72, and accordingly, the reducer 72 can be coupled to the fixture 60 conveniently with a worker's one hand. The nipple 50 can keep the water tightness by means of the first internal packing ring 21 and the first external packing ring 31.

According to the flexible hose 10 to which the connecting device is formed integrally made in the factory, the nipple 50 is rotated and coupled to the feeder pipe 71 mounted on a ceiling, and in the state where the reducer 72 is coupled to the fixture 60, the flexible hose 10 is bent to allow the reducer 72 to be coupled to a center bracket mounted on a ceiling structure. Next, after ceiling finishing work and feeding checking are completed, the sprinkler head 73 is mounted on the reducer 72.

As described above, the flexible sprinkler hose connecting device according to the present invention is configured wherein the reducer can be coupled to the fixture by the worker's one and in the state only the nipple is rotated and coupled to the feeder pipe, without fear of twisting on the flexible hose. Further, the coupled portions with the nipple and the fixture can be maintained in water tightness by means of the internal packings of the nipple and the fixture compressed against the compression grooves by the expansion portions, and if the fixture has no external packing, it is assembled to the flexible hose at an optimal state in the factory, thus maintaining the non-leakage state even upon the installation of the flexible hose.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A flexible sprinkler hose connecting device comprising:
a flexible hose having troughs and peaks continuously formed therealong and surrounded by a braided layer;
first and second non-flexible portions and formed on both ends of the flexible hose;
first and second internal rings and and first and second external rings and located on the inner and outer peripheries of the braided layer to fix the end portions of the braided layer to the first and second non-flexible portions and;
a bushing having a first coupling hole to which the first external ring is fitted, a first through hole connected to the first coupling hole, a first compression groove formed on the first through hole, and a guide groove formed on the outer periphery thereof;
a first internal, packing insertedly fitted to the first compression groove;
external packings disposed on the outer periphery of the bushing;
a first expansion portion formed by convexedly expanding a portion of the first non-flexible portion toward the first compression groove in the state where the bushing is fitted to the first non-flexible portion;
a nipple having screw holes formed on the outer peripheral surface thereof to correspond to the guide groove of the bushing in such a manner as to be penetrated into a fitting hole formed in the interior thereof;
headless bolts fitted to the guide groove through the screw holes;
a fixture having a second coupling hole to which the second external ring is fitted, a second through hole connected to the second coupling hole, a second compression groove formed on the second through hole, and an exclusive tool fitting groove formed on the outer periphery thereof;
a second internal backing fitted to the second compression groove;
a second expansion portion formed by convexedly expanding a portion of the second non-flexible portion toward the second compression groove in the state where the fixture is fitted to the second non-flexible portion; and
first and second bending portions and formed on the end peripheral portions of the first and second non-flexible portions and to fix the bushing and the fixture to the flexible hose.

2. The flexible sprinkler hose connecting device according to claim 1, wherein the bushing has packing grooves formed on the outer periphery thereof to fit portions of the external packings thereto.

3. The flexible sprinkler hose connecting device according to claim 1, wherein the fixture is coupled to a reducer.

4. The flexible sprinkler hose connecting device according to claim 3, wherein the reducer is coupled to a center bracket.
